(19) United States
(12) Patent Application Publication
(10) Pub. No.: US 2003/0158025 A1
(43) Pub. Date: Aug. 21, 2003

(54) Pull tab device for a dunnage machine stock supply

(76) Inventors: Edward W. Lintala, Concord, OH (US); Joseph J. Harding, Mentor, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/367,610

(22) Filed: Feb. 14, 2003

Related U.S. Application Data
(60) Provisional application No. 60/357,049, filed on Feb. 14, 2002.

(51) Int. Cl. B31F 7/00

(52) U.S. Cl. 493/357

(57) ABSTRACT

A label-like pull tab device releasably secures a leading end of a sheet stock material to a supply of stock material for a dunnage producing machine. The device has end portions with an adhesive on a back side, and a tab portion between the end portions. In use, one end portion is attached to the leading end of the stock material, the tab portion is placed across the leading edge of the stock material, and the other end portion, on the other side of the tab portion, is attached to the supply of stock material. The device also includes at least one tear line between the tab portion and at least one of the end portions. Pulling on the tab portion tears the device along the tear line, separating the tab portion from at least one end portion, and releasing the leading end of the stock material from the supply.

The inventors hereby claim the benefit of U.S. Provisional Patent Application No. 60/357,049, filed Feb. 14, 2002, which is hereby incorporated herein in its entirety.

### FIELD OF THE INVENTION

The present invention generally relates to stock material for a dunnage producing machine and, more particularly, to a supply of sheet stock material with a device for securing the free end of the stock material for transport and storage.

### BACKGROUND OF THE INVENTION

In the process of shipping an item from one location to another, a protective packaging material generally is placed in the shipping case, or box, to fill any voids, to cushion, to block and/or to brace the item during the shipping process. Various types of packing products have been used to pack articles in containers for shipment, including a crumpled paper dunnage product which is biodegradable, recyclable, and composed of a renewable resource, making it an environmentally responsible choice.

The conversion of sheet material, such as paper, into a crumpled dunnage product may be accomplished by a cushioning conversion machine, such as those disclosed in U.S. Pat. Nos. 4,750,896; 4,884,999; and 5,607,383. Each of the cushioning conversion machines disclosed in the above-identified patents includes a conversion assembly which converts sheet stock material composed of one or more plies into a relatively less dense three-dimensional cushioning product.

Typically, the sheet stock material is supplied on a roll that can be rotatably supported on a stock roll holder, such as an axle or a spindle, that passes through the core of the stock roll with its ends projecting therebeyond for cradled receipt in respective laterally spaced apart mounts of a roll support member on the cushioning conversion machine. To keep the sheet material from unrolling during transport and storage, a strip of tape is applied across the free end of the stock material. This tape may have applied thereto certain indicia, such as the supplier's trademark.

To use the stock material, the tape must be cut or torn by the end user to release the leading end so that the stock material can be fed into the cushioning conversion machine or spliced to a trailing end of the stock material from a previous supply. Heretofore, this has been a somewhat difficult task to perform without tearing or otherwise damaging the leading end of the stock material and/or the next adjacent layer of the stock material, even if done with the aid of a knife or razor blade cutter.

Damage to the leading end is particularly problematic if the leading end of the stock material includes an adhesive strip. Adhesive strips may be used for splicing the leading end to a trailing end of a previous supply of stock material to facilitate feeding the stock material into the machine. With the leading end spliced to the trailing end, the trailing end can pull the leading end through the machine. While splicing facilitates feeding a new supply of stock material into the machine, particularly multi-ply stock material, damage to the leading end of the stock material may hinder or eliminate the adhesive strip's ability to secure the leading and trailing ends together.

### SUMMARY OF THE INVENTION

The present invention provides a pull tab device for securing a leading end of a supply of sheet stock material. The device has a tab portion that can be separated along a tear line to release the leading end of the stock material without requiring any tools and without tearing the stock material. Consequently, the present invention improves the utilization efficiency of a supply of sheet stock material for a cushioning conversion machine or other dunnage producing machine.

Specifically, the pull tab device is formed of a sheet material having end portions connected to a tab portion interposed between the end portions, and at least one tear line between the tab portion and at least one of the end portions. The end portions each have an adhesive on a back side thereof for attaching one end portion to the leading end of the stock material and the other end portion to the supply of stock material, whereby the tab portion may be separated from at least one end portion along the tear line therebetween to release the leading end of the stock material from the stock supply.

In an exemplary embodiment, the tab portion is free of adhesive. The tab portion may protrude beyond an area encompassing the adhesive to facilitate grasping and pulling the tab portion. Also, in an exemplary embodiment, indicia may be applied to a front side of the pull tab device, including identifying information, instructions for applying the device to a stock supply, and instructions for releasing the leading end of the stock material by separating the tab portion from at least one end portion along the tear line therebetween. The tear line may be formed by perforations, and may extend across the width of the device, or only part of the width.

The present invention also provides a supply of sheet stock material in combination with the pull tab device, and a method of using the pull tab device. In use, the pull tab device is applied across a leading edge of the leading end of the supply of sheet stock material. One end portion is attached to the leading end of the stock material and the other end portion is attached to the stock supply, such that the leading edge of the leading end of the stock material is located between the adhesive areas on the end portions. When an operator is ready to load a new supply of sheet stock material into a machine, the leading end of the stock material is released by grasping the tab portion and pulling so that the tab portion separates from at least one of the end portions along the tear line therebetween. The leading end of the stock material may be spliced to a trailing end of a previous supply of stock material to complete the loading operation.

Consequently, the pull tab device provided by the present invention advantageously releasably secures the leading end of a supply of sheet stock material to a supply thereof for a dunnage producing machine while at the same time minimizing or eliminating tearing of the stock material when releasing the leading end from the supply prior to feeding into a machine for conversion into a dunnage product.

The foregoing and other features of the invention are hereinafter fully described and particularly pointed out in the claims, the following description and annexed drawings setting forth in detail a certain illustrative embodiment of the invention, this embodiment being indicative, however, of but one of the various ways in which the principles of the invention may be employed.

### BRIEF DESCRIPTION OF THE DRAWINGS

FIG. 1 is a top view of a pull tab device according to the present invention. FIG. 2 is a bottom view of the pull tab device shown in FIG. 1.

FIG. 3 is an illustration of a pull tab device in accordance with the present invention attached to a roll of sheet stock material.

FIG. 4 is a schematic illustration showing removal of a tab portion of the device shown in FIG. 3 to free the leading end of the sheet stock material from the roll.

FIGS. 5-8 are schematic illustrations of alternative embodiments of a pull tab device in accordance with the present invention.

### DETAILED DESCRIPTION

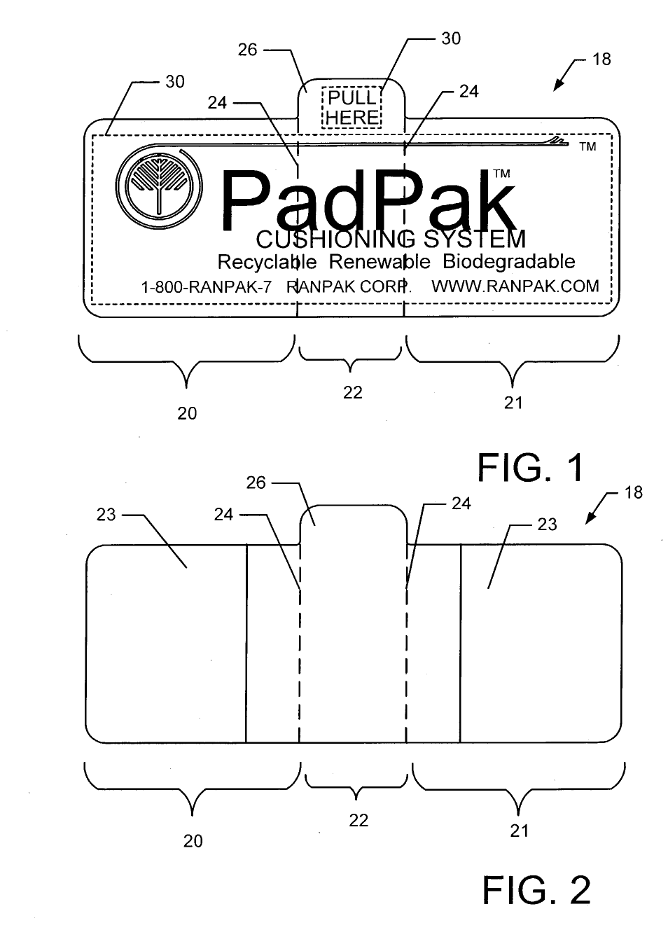

Referring initially to FIGS. 1 and 2, a pull tab device according to the invention is generally indicated at 18. The pull tab device 18 is used to secure a leading end of a sheet stock material to a supply thereof for a dunnage producing machine, such as a cushioning conversion machine.

The pull tab device 18 generally is formed of a sheet material. The device has opposing end portions 20, 21 connected to a tab portion 22 interposed therebetween. The end portions 20, 21 include an adhesive 23 on a back side of the sheet for attaching the device to the stock supply. An exemplary tab portion 22 is free of adhesive.

The pull tab device 18 also includes at least one tear line 24 between the tab portion 22 and at least one of the end portions 20, 21, defined as lines along which the tab portion 22 would separate from at least one of the end portions 20, 21. In the embodiment shown in FIGS. 1 and 2, the pull tab device 18 includes a pair of tear lines 24 between the tab portion 22 and respective end portions 20, 21. The tear lines 24 enable the tab portion 18 to be separated from one or both of the end portions 20, 21 along the tear line therebetween. The tear lines may be formed by slits, perforations or other means for weakening the sheet material, or the tear lines may arise as a result of one or more properties of the sheet material that facilitate separating the tab portion in a direction parallel to the intended path of the line of separation and resist separation in a direction transverse to the line of separation. Additionally, the tear lines may include perforations, for example, that extend across the width of the device as shown in FIG. 1, or only a short distance sufficient to facilitate an initial tearing along the line of separation between the tab portion 18 and one or more of the end portions 20, 21.

In the illustrated embodiment, a pull tab section 26 of the tab portion 22 protrudes beyond the area encompassing the adhesive areas on the end portions 20, 21. The protruding section facilitates grasping and pulling the tab portion 22 to separate the tab portion 22 along the tear lines 24 from one or both of the end portions 20, 21.

The pull tab device 18 can further include indicia 30 applied to a front side of the sheet material. The indicia 30 may include identifying information, such as the type, quality and/or brand of stock material, supplier or distributor of the stock material, a serial or lot number, etc. The indicia 30 may also include instructions for applying and/or removing the device 18 and/or the tab portion 22 from the supply of stock material.

An exemplary device 18 is approximately five inches long (about twelve and a half centimeters) and about two inches (about five centimeters) wide. An exemplary tab portion 22 has a length of about two and a quarter inches (about five and a half centimeters) such that the pull tab section 26 protrudes approximately three eighths of an inch (about one centimeter) from the region bounded by the end portions 20, 21. The tab portion 22 has a width of approximately one inch (about two and a half centimeters). The adhesive 23 on the back of the end portions 20, 21 is spaced about half an inch (about one and three tenths centimeters) from the tear lines 24 on respective sides of the tab portion 22. This provides a buffer zone between the tear lines 24 and the adhesive areas of the end portions 20, 21 that helps to ensure that the tab portion 22 is free of adhesive. Although the device may perform its intended function satisfactorily if the adhesive bleeds over to the tab portion 22, the tab portion preferably is free of adhesive.

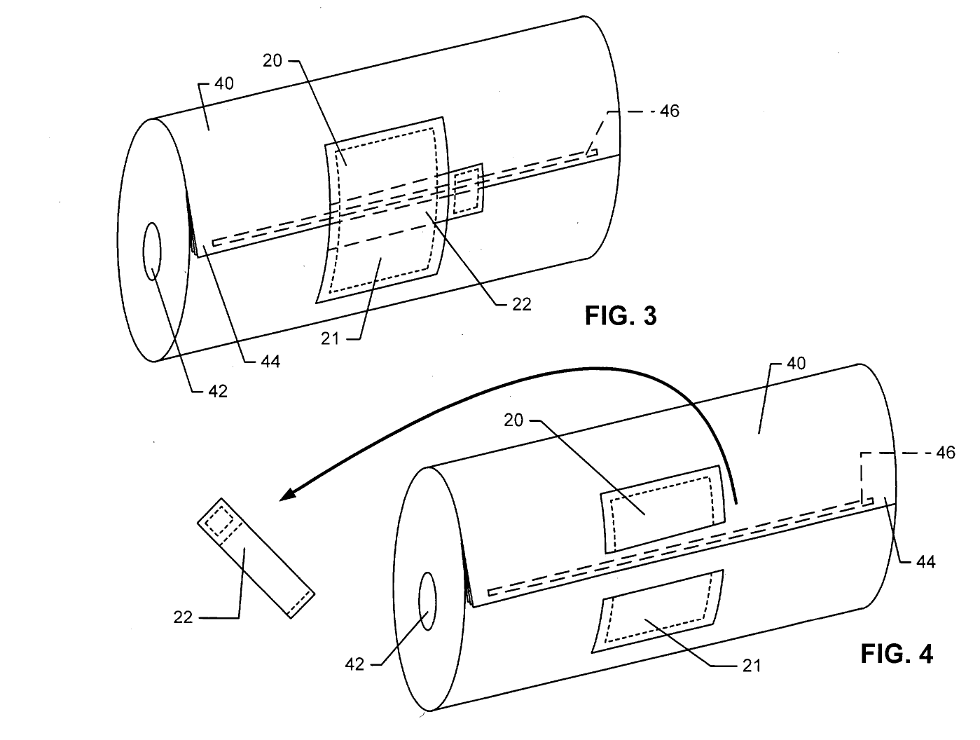

Referring to FIGS. 2 and 3, an exemplary supply of sheet stock material includes a stock roll 40 formed of a single or multi-ply sheet material wound on a hollow core 42. The core generally has an internal diameter of approximately three inches (about seven and a half centimeters) and an exemplary stock roll has a wound diameter of about twelve inches (about thirty centimeters). In an exemplary embodiment, the sheet stock material is multi-ply sheet stock material having two or three superimposed plies. The stock material itself may be selected from any sheet material suitable for conversion into a dunnage product, such as an environmentally responsible material that is biodegradable, reusable, and composed of a renewable resource, e.g., kraft paper. Exemplary stock material is disclosed in U.S. Pat. Nos. 4,750,896, 4,884,999 and 5,607,383, and commonly owned U.S. Pat. No. 09/595,104 filed Jun. 16, 2000, which are hereby incorporated herein in their entirety by this reference.

In the illustrated arrangement, the pull tab device 18 is attached to the stock supply to secure a leading end 44 of the stock material. The end portions 20, 21 of the illustrated embodiment straddle the leading edge of the leading end 44. A first end portion 20 is affixed to the leading end 44 and a second end portion 21 is affixed to the next adjacent layer or other portion of the stock material in the stock supply, with the device 18, specifically the tab portion 22, extending over the leading edge.

With the adhesive 23 (FIG. 2) located on the end portions 20, 21, separation of the tab portion 22 from either of the end portions 20, 21 releases the leading end 44 from the stock roll 40 without requiring any tools and without tearing the stock material. In the illustrated embodiment, the tab portion 22 completely separates from both end portions 20, 21 (FIG. 4).

The illustrated stock material also includes a splicing adhesive 46 pre-applied to the leading end 44 for splicing the stock material to the trailing end of a previous supply of stock material. Thus, the present invention also minimizes or eliminates damage to the splicing adhesive from the process of releasing the leading end from the stock roll 40.

The device 18 also provides a clean leading edge without wasting stock material. A torn leading edge generally would be trimmed away from the stock material to provide a clean edge or an acceptably presentable dunnage product.

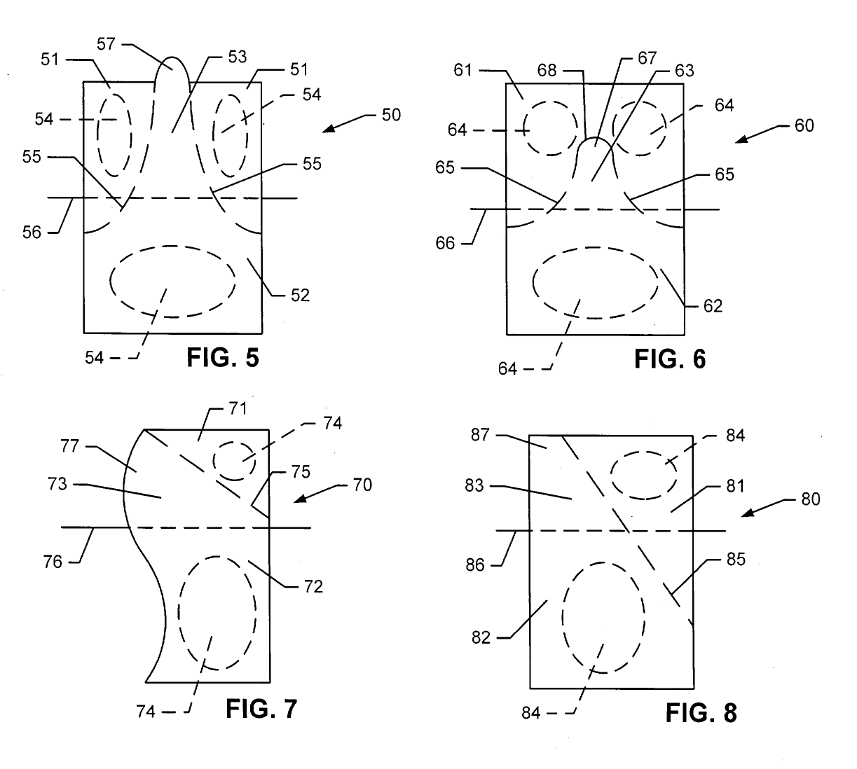

Alternative embodiments of the pull tab device (50; 60; 70; 80) are shown in FIGS. 5-8. Each embodiment includes end portions (51, 52; 61, 62; 71, 72; 81, 82) and a tab portion (53; 63; 73; 83). The end portions have adhesive (54; 64; 74; 84) applied to a back side thereof. Each device also includes at least one tear line (55; 65; 75; 85) adjacent the tab portion. The adhesive and the tear lines are arranged so that the device can be applied to releasably secure a leading end (56; 66; 76; 86) of the stock material to the stock supply. When the tab portion is pulled by the end user, the tab portion separates from at least one end portion along the at least one tear line therebetween, thereby releasing the leading end (56; 66; 76; 86) of the stock material.

In contrast to the embodiment in FIGS. 1-4, in each of these devices (50; 60; 70; 80) the tab portion (53; 63; 73; 83) remains attached to one of the end portions (51, 52; 61, 62; 71, 72; 81, 82). Thus none of the device needs to be discarded after the leading end of the stock material is released, and the pull tab device will be incorporated into a completed dunnage product as the stock material is fed into the machine.

The device 55 shown in FIG. 5 has a protruding pull tab section 57 extending between two regions of adhesive 54 in one end portion 51 to facilitate grasping the pull tab and separating the tab portion 53 from the end portion 51.

The device 60 shown in FIG. 6 also has a pull tab 67. This pull tab does not protrude from the device 60. Rather the pull tab is contained within the boundaries of the device 60 and is interposed between the end portions 61, 62. The pull tab is partially separated from the end portions by a line 68 that with a pair of tear lines 65 form a continuous line between two edges of the pull tab device 60. The pull tab is readily lifted from the plane of the device and pulled to separate the tab portion 63 from one end portion 61.

In FIGS. 7 and 8, a single tear line (75; 85) separates the end portions (71, 72; 81, 82). A pull tab (77; 87) can be pulled to separate the tab portion (73; 83) from one end portion (71; 81) along the tear line therebetween.

The embodiments presented in FIGS. 6-8 have as a further advantage their economical use of sheet material used to form the respective pull tab devices. Although these devices primarily have rectangular shapes, other shapes may as readily be used that provide for quick and simple separation of adhesive areas that otherwise secure the leading end of the stock material to the supply thereof (compare FIGS. 7 and 8).

Although the invention has been shown and described with respect to certain illustrated embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiments of the invention. In addition, while a particular feature of the invention may have been described above with respect to only one of several illustrated embodiments, such a feature may be combined with one or more other features of the other embodiment, as maybe desired and advantageous for any given or particular application.

What is claimed is:

1. In combination with a supply of sheet stock material, a pull tab device for releasably securing a leading end of the stock material to the supply, the device having opposite end portions connected to a tab portion interposed therebetween, and at least one tear line between the tab portion and at least one of the end portions, one end portion being attached to a leading end of the stock material and the other end portion being attached to the stock supply, whereby the tab portion may be separated from at least one end portion along the tear line therebetween to release the leading end of the stock material from the stock supply.

2. A combination as set forth in claim 1, wherein the stock material is suitable for conversion into a cushioning product.

3. A combination as set forth in claim 1, wherein the stock material is selected from stock materials that are biodegradable, reusable, and composed of a renewable resource.

4. A combination as set forth in claim 1, wherein the stock material is kraft paper.

5. A combination as set forth in claim 1, wherein the stock material is a multi-ply sheet stock material.

6. A combination as set forth in claim 1, wherein the stock material is a three-ply sheet stock material.

7. A combination as set forth in claim 1, wherein the end portions have an adhesive on a back side thereof for attaching the end portions to the stock material.

8. A combination as set forth in claim 7, wherein the tab portion is free of adhesive.

9. A combination as set forth in claim 1, wherein the at least one tear line includes two tear lines, with one tear line between the tab portion and the respective end portion, such that separation along the tear lines completely separates the tab portion from both end portions.

10. A combination as set forth in claim 1, wherein the tear line extends across the width of the device.

11. A pull tab device for releasably securing a leading end of a supply of sheet stock material, comprising end portions connected to a tab portion interposed between the end portions, and at least one tear line between the tab portion and at least one of the end portions, the end portions each having an adhesive on a back side thereof for attaching one end portion to the leading end of the stock material and the other end portion to the supply of stock material, whereby the tab portion may be separated from at least one end portion along the tear line therebetween to release the leading end of the stock material from the stock supply.

12. A device as set forth in claim 11, further comprising indicia on a front side of the sheet, the indicia having at least one of identifying information, instructions for applying the device to the stock supply, and instructions for releasing the leading end of the stock material by separating the tab portion from at least one end portion along the tear line therebetween.

13. A device as set forth in claim 11, wherein the at least one tear line includes two tear lines, with one tear line between the tab portion and the respective end portion, such that separation along the tear lines completely separates the tab portion from both end portions.

14. A device as set forth in claim 11, wherein the tear line extends across the width of the device.

15. A device as set forth in claim 11, wherein the tear line is formed by perforations.

16. A device as set forth in claim 11, wherein the adhesive is spaced from the tear line.

17. A device as set forth in claim 11, wherein the tab portion is free of adhesive.

18. A device as set forth in claim 11, wherein the tab portion protrudes beyond an area that encompasses the adhesive.

19. A method of feeding a sheet stock material into a cushioning conversion machine from a supply of sheet stock material having a leading end of the stock material secured to the supply with a device having opposite end portions connected to a tab portion interposed therebetween, and at least one tear line between the tab portion and at least one of the end portions, one end portion being attached to a leading end of the stock material and the other end portion being attached to the stock supply, the method comprising the step of releasing the leading end of the stock material by separating the tab portion from at least one of the end portions along the tear line therebetween.

20. A method as set forth in claim 19, further comprising the step of splicing the leading end of the stock material to a trailing end of a previous supply of stock material.
